(19) United States
(12) Patent Application Publication
(10) Pub. No.: US 2025/0286942 A1
(43) Pub. Date: Sep. 11, 2025

(54) CONNECTION STRUCTURE AND PORTABLE STORAGE DEVICE

(71) Applicant: Lexar Electronics (Shenzhen) Co., Ltd., SHENZHEN (CN)

(72) Inventors: Zutao QIU, SHENZHEN (CN); Wei LIN, SHENZHEN (CN); Quangui LIU, SHENZHEN (CN); Xiping ZHOU, SHENZHEN (CN)

(73) Assignee: Lexar Electronics (Shenzhen) Co., Ltd., SHENZHEN (CN)

(21) Appl. No.: 19/071,049

(22) Filed: Mar. 5, 2025

(30) Foreign Application Priority Data
Mar. 6, 2024 (CN) 202420436335.7

(51) Int. Cl. H04M 1/02; H01R 31/06

(52) U.S. Cl. CPC H04M 1/0274; H01R 31/06; H01R 2201/16

(57) ABSTRACT

A connection structure includes: a housing; an interface member, where at least a portion of the interface member extends from a first side wall of the housing to an outside of the housing to be connected with an interface of an electronic device; and a blocking portion, where the blocking portion is arranged on the first side wall of the housing, the blocking portion extends from the first side wall towards the outside of the housing and surrounds an intersection of the interface member and the first side wall.

### CROSS REFERENCE TO RELATED APPLICATIONS

The present application claims the priority of the Chinese patent application No. 202420436335.7, filed on Mar. 6, 2024, the entire contents of which are hereby incorporated by reference in their entireties.

### TECHNICAL FIELD

The present disclosure relates to the technical field of electrics, and in particular to a connection structure and a portable storage device.

### BACKGROUND

A portable storage device, such as a portable solid-state drive, has a small size, can be portable easily, and has a large storage capacity.

In order to protect a mobile phone, a user usually cover the mobile phone with a phone case. In the art, an interface member of the portable storage device may be excessively long. In this case, as shown in FIG. 1, when the portable storage device is used with the mobile phone covered with the phone case, and when a connecting structure in the art having the excessively long interface member is connected to an interface of the mobile phone covered with the phone case, a portion of the interface member may be exposed to an outside, protection for electrostatic discharge (ESD) and electromagnetic compatibility (EMC) may be weakened, and an outer appearance is unpleased. Alternatively, in the art, a male connector of the portable storage device may be configured to be excessively short, as shown in FIG. 2, which is a schematic view of the connection structure in the art having the excessively short interface member being connected to the interface of the mobile phone covered with the phone case. As shown in FIG. 2, when the male connector is excessively short, poor signal connection may be caused.

### SUMMARY OF THE DISCLOSURE

The present disclosure provides a connection structure and a portable storage device, to solve the above technical problems.

In a first aspect, the present disclosure provides a connection structure, including: a housing; an interface member, wherein at least a portion of the interface member extends from a first side wall of the housing to an outside of the housing to be connected with an interface of an electronic device; and a blocking portion, wherein the blocking portion is arranged on the first side wall of the housing, the blocking portion extends from the first side wall towards the outside of the housing and surrounds an intersection of the interface member and the first side wall.

In some embodiments, a height of the blocking portion extending towards the outside of the housing is not less than 1.6 millimeters.

In some embodiments, the height of the blocking portion extending towards the outside of the housing is 1.6 millimeters.

In some embodiments, the interface member is one of: a Type-C interface, a lightning interface, a Micro USB interface, and a MiniUSB interface.

In some embodiments, the interface member is the Type-C interface, the interface member comprises a snapping segment that is not surrounded by the blocking portion, the snapping segment has an extension height of not less than 6.5 millimeters.

In some embodiments, a width of the blocking portion is less than 12 millimeters.

In some embodiments, a size of the blocking portion is progressively reduced along a direction of extending towards the outside of the housing.

In some embodiments, connection between a second side wall of the blocking portion and a surface of the blocking portion away from the housing is a curved surface.

In some embodiments, the blocking portion and the housing are configured as an integral and one-piece structure; the blocking portion is formed by a portion of the first side wall of the housing protruding outwardly.

In a second aspect, the present disclosure provides a portable storage device, including: a body portion; and the connection structure as described in the above. The body portion is arranged inside the housing of the connection structure.

According to the present disclosure, the connection structure and the portable storage device are provided. The connection structure includes the housing, the interface member, and the blocking portion. At least a portion of the interface member extends from a first side wall of the housing to the outside of the housing to be connected with the interface of the electronic device. The blocking portion is arranged on the first side wall of the housing. The blocking portion extends from the first side wall to the outside of the housing and surrounds the intersection of the interface member and the first side wall. The blocking portion is disposed surrounding the intersection of the interface member and the first side wall of the connection structure. When the connection structure is connected to the mobile phone covered with the phone case, the portion of the interface member not surrounded by the blocking portion is inserted in the interface of the mobile phone. The region of the interface member at the opening of the phone case is blocked by the blocking portion, preventing the interface member from being exposed at the opening. In this way, exposure of the interface member, due to the interface member being excessively long, may be avoided; and poor signal connection, due to the interface member being excessively short, may be avoided.

### BRIEF DESCRIPTION OF THE DRAWINGS

In order to more clearly illustrate technical solutions in embodiments of the present disclosure, accompanying drawings used for describing the embodiments will be briefly introduced in the following. Apparently, the accompanying drawings in the following description show only some of the embodiments of the present disclosure, and other accompanying drawings may be obtained according to the following drawings by any ordinary skilled person in the art without making any creative work.

FIG. 1 is a structural schematic view of the connection member in the art, when having the excessively long interface member, being connected to the interface of the mobile phone covered with the phone case.

FIG. 2 is a structural schematic view of the connection member in the art, when having the excessively short interface member, being connected to the interface of the mobile phone covered with the phone case.

FIG. 3 is a structural schematic view of a connection structure according to an embodiment of the present disclosure.

FIG. 4 is a structural schematic view of the connection structure being connected with an interface of a mobile phone that is uncovered with a phone case, according to an embodiment of the present disclosure.

FIG. 5 is a structural schematic view of the connection structure being connected with the interface of the mobile phone that is covered with the phone case, according to an embodiment of the present disclosure.

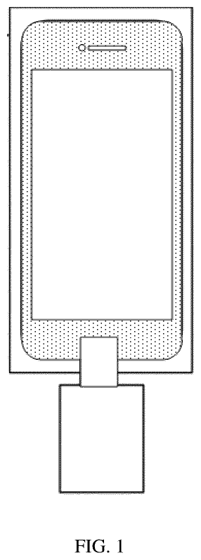

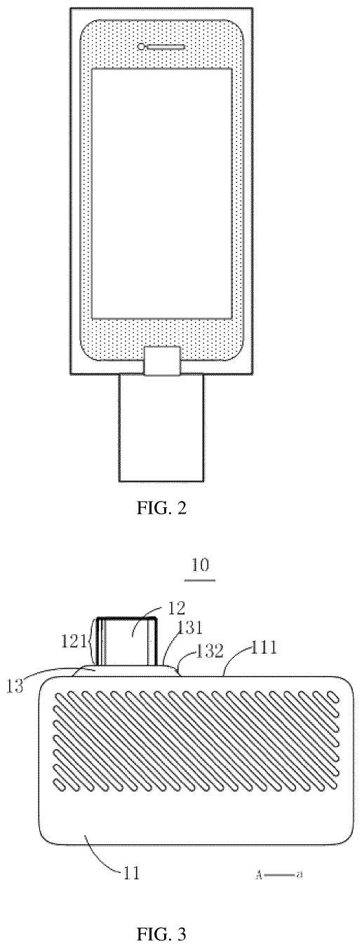

Reference numerals in the drawings: 10, connection structure; 11, housing; 111, first side wall; 12, interface member; 121, snapping segment; 13, blocking portion; 131, surface; 132, second side wall; 20, mobile phone; 30, phone case.

### DETAILED DESCRIPTION

The technical solutions in the embodiments of the present disclosure will be described clearly and completely in the following by referring to the accompanying drawings in the embodiments of the present disclosure. Apparently, the described embodiments are only a part of, not all of, the embodiments of the present disclosure. All other embodiments, which are obtained by any ordinary skilled person in the art based on the embodiments in the present disclosure without making creative work, shall be within the scope of the present disclosure.

Terms used in the embodiments of the present disclosure are used merely for the purpose of describing particular embodiments and are not intended to limit the present disclosure. Any singular form of “a”, “said”, and “the” used in the embodiments and in the claims are intended to include a plural form of a structure, unless clearly indicated in the context. “A plurality of” generally means at least two, but does not preclude a situation that the number of structures is at least one.

It should be understood that the term “and/or” used herein is merely a description of an association relationship of objects, indicating that three types of relationships may exist. For example, A and/or B may mean that A is present alone, both A and B are present, and B is present alone. In addition, the character “/” herein indicates that an object before the character “or” an object after the character.

It should be understood that terms “include”, “comprise”, or any other variant used herein are intended to encompass non-exclusive inclusion, such that a process, a method, an article or an apparatus includes not only the listed elements but also other elements that are not explicitly listed or elements that are inherently included in the process, the method, the article or the apparatus. Without further limitation, an element defined by a phrase “including . . . ” does not exclude existence of another identical element included in the process, the method, the article, or the apparatus.

When a portable storage device is used with a mobile phone covered with a phone case, usage of the portable storage device may be affected when an interface member of the portable storage device is excessively long or excessively short.

Accordingly, the present disclosure provides a connection structure and a portable storage device, a blocking portion surrounding the interface member is formed at an intersection of the interface member and the housing, so as to solve the above problems effectively.

A card reader provided by the present disclosure will be described in detail below by referring to the accompanying drawings and embodiments.

The present disclosure provides a connection structure. As shown in FIG. 3, FIG. 3 is a structural schematic view of the connection structure according to an embodiment of the present disclosure. The connection structure 10 of the present disclosure may be configured in a portable storage device, such as a portable solid-state drive, a portable micro-drive, and so on, serving as a male connector to be connected with an interface of an electronic device, such as a mobile phone 20. The connection structure 10 may alternatively be configured in a charging cable or a data cable to be connected with the interface of the mobile phone 20. The present disclosure does not limit an application of the connection structure. In the present embodiment, the connection structure 10 includes a housing 11, an interface member 12, and a blocking portion 13.

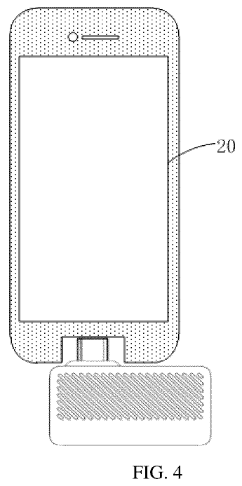

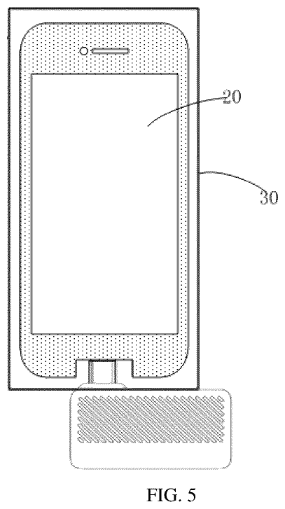

At least a portion of the interface member 12 extends from a first side wall 111 of the housing 11 to an outside of the housing 11 to be connected with the interface of the electronic device. The blocking portion 13 is arranged on the first side wall 111 of the housing 11. The blocking portion 13 extends from the first side wall 111 to the outside of the housing 11 and surrounds an intersection of the interface member 12 and the first side wall 111. Specifically, the interface member 12 of the connection structure 10 is configured to be connected with the interface of a device, such as the mobile phone, a computer, and the like, so as to achieve data transmission or charging with the interface of the device. The interface member 12 of the connection structure 10 is longer than the interface member 12 in the art, and the blocking portion 13 is arranged surrounding the intersection of the interface member 12 and the first side wall 111. In the present embodiment, the device is the mobile phone 20, as shown in FIG. 4, FIG. 4 is a structural schematic view of the connection structure being connected with the interface of the mobile phone that is uncovered with the phone case, according to an embodiment of the present disclosure. Since the interface member 12 of the connection structure 10 of the present disclosure is longer than the interface member 12 in the art, when the mobile phone 20 is not covered with the phone case 30, a portion of the interface member 12 that is not surrounded by the blocking portion 13 is inserted into the interface of the mobile phone 20, and a portion of the interface member 12 disposed outside the interface of the mobile phone 20 is blocked by the blocking portion 13. In this way, protection for ESD and EMC is ensured, and a pleased outer appearance is provided. As shown in FIG. 5, FIG. 5 is a structural schematic view of the connection structure being connected with the interface of the mobile phone that is covered with the phone case, according to an embodiment of the present disclosure. The portion of the interface member 12 that is not surrounded by the blocking portion 13 is inserted into the interface of the mobile phone 20, and a region of the interface member 12 disposed at an opening of the phone case 30 is blocked by the blocking portion 13. In this way, exposure of the interface member 12 at the opening is avoided. Exposure of the interface member 12, due to the interface member 12 excessively long, may be avoided; and poor signal connection, due to the interface member 12 excessively short, may be avoided.

According to the present disclosure, the connection structure 10 is provided. The interface member 12 of the connection structure 10 is longer than interface member 12 in the art, and the blocking portion 13 is arranged surrounding the intersection of the interface member 12 and the first side wall 111. When the connection structure 10 is connected to the mobile phone 20 covered with the phone case 30, the portion of the interface member 12 that is not surrounded by the blocking portion 13 is inserted into the interface of the mobile phone 20, and the region of the interface member 12 disposed at the opening of the phone case 30 is covered by the blocking portion 13. In this way, exposure of the interface member 12 at the opening is prevented. Exposure of the interface member 12, due to the interface member 12 excessively long, may be avoided; and poor signal connection, due to the interface member 12 excessively short, may be avoided.

Further, in the present embodiment, the blocking portion 13 surrounds the intersection of the interface member 12 and the first side wall 111, such that the blocking portion 13 provides a more effective blocking effect, the portion of the interface member 12 disposed at the opening of the phone case 30 is completed blocked, preventing the exposure of the interface member 12. In some embodiments, the blocking portion 13 may be arranged to attach to at least a portion of the intersection of the interface member 12 and the first side wall 111. That is, the blocking portion 13 does not completely surround the interface member 12, and in this case, the blocking portion 13 still prevents the exposure of the interface member 12.

In the present embodiment, a height of the blocking portion 13 that extends towards the outside of the housing 11 is not less than 1.6 millimeters. In this way, the height of the blocking portion 13 greater than or equal to a thickness of the phone case 30, such that the portion of the interface member 12 not surrounded by the blocking portion 13 can be completely inserted into the interface of the mobile phone 20, ensuring connection reliability. The height of the blocking portion 13 may be any proper value, such as 1.6 millimeters, 1.7 millimeters, 2 millimeters, 2.5 millimeters, and the like, which is not limited herein. The height of the blocking portion 13 may be adaptively adjusted based on the thickness of the phone case 30. For example, in some embodiments, when the thickness of the phone case 30 is 2 millimeters, the height of the blocking portion 13 is not less than 2 millimeters; when the thickness of the phone case 30 is 2.5 millimeters, the height of the blocking portion 13 is not less than 2.5 millimeters. In some embodiments, the height of the blocking portion 13 extending towards the outside of the housing 11 is 1.6 mm.

Further, the interface member 12 is one of: a Type-C interface and a lightning interface. Specifically, the Type-C interface and the lightning interface are common interfaces of the mobile phone 20 and can meet requirements of fast charging and high-speed data transmission. In some embodiments, the interface member 12 may be a mini universal serial bus (mini USB) interface, a micro USB interface, or an interface in other types. A type of the interface is not limited herein.

In the present embodiment, the interface member 12 is the Type-C interface, and the interface member 12 includes a snapping segment 121 that is not surrounded by the blocking portion 13. An extending height of the snapping segment 121 is not less than 6.5 millimeters. Specifically, the snapping segment 121 is a portion of the interface member 12 that is inserted into the interface of the mobile phone 20. The height of the snapping segment 121 is configured to be not less than 6.5 millimeters, so as to enable the interface member 12 to have a sufficient length to be inserted into the interface of the mobile phone 20 and to ensure connection reliability. The height of the snapping segment 121 of the interface member 12 is determined according to industrial design specifications for Type-C interfaces. The height of the snapping segment 121 shall be greater than or equal to a depth of the interface of the mobile phone 20 and is less than a sum of the depth of the interface of the mobile phone 20 and the thickness of the phone case 30. For example, the height of the snapping segment 121 may be any proper value such as 6.5 mm, 6.7 mm, 7 mm, and the like.

Further, in the present embodiment, a width of the blocking portion 13 is less than 12 millimeters. Specifically, a width direction is a direction A-a as shown in FIG. 3. The width of the blocking portion 13 is configured to be less than 12 mm, so as to enable the blocking portion 13 to be inserted into the opening of the phone case 30 to ensure that the snapping segment 121 of the blocking portion 13 to be inserted into the interface of the mobile phone 20. In addition, the width of the blocking portion 13 is greater than the width of the interface member 12 to enable the blocking portion 13 to provide the blocking effect. The width of the blocking portion 13 may be 11.9 mm, 11.5 mm, 11 mm, and so on, which is not limited herein. In the present embodiment, the width of the blocking portion 13 is 11.5 mm.

Further, in the present embodiment, a size of the blocking portion 13 is progressively reduced in a direction extending towards the outside of the housing 11. Specifically, as shown in FIG. 3, the size of the blocking portion 13 is progressively reduced in an extending direction of the interface member 12, and an end of the blocking portion 13 that is inserted into the opening of the phone case 30 has a smallest size. In this way, when the interface member 12 is inserted, the blocking portion 13 provides guidance. When the end of the blocking portion 13 that is inserted into the opening of the phone case 30 has the smallest size, the blocking portion 13 may be better aligned with the opening of the phone case 30, facilitating the blocking portion 13 to be conveniently connected to the interface of the mobile phone 20.

Further, in the present embodiment, a second side wall 132 of the blocking portion 13 is connected to a surface 131 of the blocking portion 13 away from the housing 11 through a curved section. In this way, an edge of the blocking portion 13 is curved, and a corner is smooth, and the connection structure 10 has an aesthetic outer appearance, the user may have a better touch feeling. In some embodiments, the second side wall 132 of the blocking portion 13 and the surface 131 of the blocking portion 13 away from the housing 11 may be connected to each other at a right angle. The connection therebetween is not limited herein. In some embodiments, a cross section of the blocking portion 13, taken along an outward direction along the first side wall 111 of the housing 11, may be trapezoidal. For example, the cross section of the blocking portion 13, taken along a plane that is perpendicular to the surface 131 of the blocking portion 13 away from the first side wall 111, is trapezoidal. That is, connection between the second side wall 132 of the blocking portion 13 and the surface 131 of the blocking portion 13 away from the housing 11 may be a plane. In some embodiments, the cross section of the blocking portion 13, taken along the outward direction along the first side wall 111 of the housing 11, may be trapezoidal oval, rectangular, rounded rectangular, and so on, which is not limited herein, as long as the blocking portion 13 surrounds the intersection of the interface member 12 and the first side wall 111.

In the present embodiment, the blocking portion 13 and the housing 11 are configured as an integral and one-piece structure. The blocking portion 13 is formed by the first side wall 111 of the housing 11 protruding outwardly. Specifically, the blocking portion 13 and the housing 11 may be formed by integrally injection molding. By configuring the blocking portion 13 and the housing 11 as the integral and one-piece structure, the connection structure 10 is more reliable and structurally stable, and is likely to be damaged. In some embodiments, the blocking portion 13 and the housing 11 may be manufactured separately, and then the blocking portion 13 and the housing 11 are snapped to each other, and in this way, the blocking portion 13 and the housing 11 are structures that are separatable from each other.

Further, in some embodiments, the blocking portion 13 may be a flexible structure, such as a rubber blocking portion 13, a flexible plastic blocking portion 13, and the like. In this way, the blocking portion 13 is prevented from damaging the interface of the mobile phone 20, such that protection is provided.

According to the present disclosure, the connection structure 10 is provided. The interface member 12 of the connection structure 10 is longer than interface member 12 in the art, and the blocking portion 13 is arranged surrounding the intersection of the interface member 12 and the first side wall 111. When the connection structure 10 is connected to the mobile phone 20 covered with the phone case 30, the portion of the interface member 12 that is not surrounded by the blocking portion 13 is inserted into the interface of the mobile phone 20, and the region of the interface member 12 disposed at the opening of the phone case 30 is covered by the blocking portion 13. In this way, exposure of the interface member 12 at the opening is prevented. Exposure of the interface member 12, due to the interface member 12 excessively long, may be avoided; and poor signal connection, due to the interface member 12 excessively short, may be avoided.

Correspondingly, the present disclosure further provides the portable storage device, the portable storage device includes a body portion and the connection structure as described in the above embodiments. The body portion is disposed inside the housing of the connection structure.

The above shows only embodiments of the present disclosure, and does to limit the scope of the present disclosure. Any equivalent structure or equivalent principle transformation, which are performed based on the contents of the specification and the accompanying drawings of the present disclosure and are applied directly or indirectly in other related fields, shall be equivalently included in the scope of the present disclosure.

What is claimed is:

1. A connection structure, comprising:
a housing;
an interface member, wherein at least a portion of the interface member extends from a first side wall of the housing to an outside of the housing to be connected with an interface of an electronic device; and
a blocking portion, wherein the blocking portion is arranged on the first side wall of the housing, the blocking portion extends from the first side wall towards the outside of the housing and surrounds an intersection of the interface member and the first side wall.

2. The connection structure according to claim 1, wherein a height of the blocking portion extending towards the outside of the housing is not less than 1.6 millimeters.

3. The connection structure according to claim 2, wherein the height of the blocking portion extending towards the outside of the housing is 1.6 millimeters.

4. The connection structure according to claim 1, wherein the interface member is one of: a Type-C interface, a lightning interface, a Micro USB interface, and a MiniUSB interface.

5. The connection structure according to claim 4, wherein the interface member is the Type-C interface, the interface member comprises a snapping segment that is not surrounded by the blocking portion, the snapping segment has an extension height of not less than 6.5 millimeters.

6. The connection structure according to claim 5, wherein a height of the snapping segment is greater than or equal to a depth of the interface of the electronic device and is less than a sum of the depth of the interface of the electronic device and a thickness of a protective case that covers the electronic device.

7. The connection structure according to claim 1, wherein a width of the blocking portion is less than 12 millimeters.

8. The connection structure according to claim 1, wherein a size of the blocking portion is progressively reduced along a direction of extending towards the outside of the housing.

9. The connection structure according to claim 8, wherein a cross section of the blocking portion, taken along a plane that is perpendicular to a surface of the blocking portion away from the first side wall, is trapezoidal.

10. The connection structure according to claim 8, wherein connection between a second side wall of the blocking portion and a surface of the blocking portion away from the housing is a curved surface.

11. The connection structure according to claim 1, wherein the blocking portion and the housing are configured as an integral and one-piece structure; the blocking portion is formed by a portion of the first side wall of the housing protruding outwardly.

12. A portable storage device, comprising:
a body portion; and
a connection structure,
wherein the connection structure, comprises:
a housing;
an interface member, wherein at least a portion of the interface member extends from a first side wall of the housing to an outside of the housing to be connected with an interface of an electronic device; and
a blocking portion, wherein the blocking portion is arranged on the first side wall of the housing, the blocking portion extends from the first side wall towards the outside of the housing and surrounds an intersection of the interface member and the first side wall; and
the body portion is arranged inside the housing of the connection structure.

13. The portable storage device according to claim 12, wherein a height of the blocking portion extending towards the outside of the housing is not less than 1.6 millimeters.

14. The portable storage device according to claim 13, wherein the height of the blocking portion extending towards the outside of the housing is 1.6 millimeters.

15. The portable storage device according to claim 12, wherein the interface member is one of: a Type-C interface, a lightning interface, a Micro USB interface, and a MiniUSB interface.

16. The portable storage device according to claim 15, wherein the interface member is the Type-C interface, the interface member comprises a snapping segment that is not surrounded by the blocking portion, the snapping segment has an extension height of not less than 6.5 millimeters.

17. The portable storage device according to claim 12, wherein a width of the blocking portion is less than 12 millimeters.

18. The portable storage device according to claim 12, wherein a size of the blocking portion is progressively reduced along a direction of extending towards the outside of the housing.

19. The portable storage device according to claim 18, wherein connection between a second side wall of the blocking portion and a surface of the blocking portion away from the housing is a curved surface.

20. The portable storage device according to claim 12, wherein the blocking portion and the housing are configured as an integral and one-piece structure; the blocking portion is formed by a portion of the first side wall of the housing protruding outwardly.
